(19) United States
(12) Patent Application Publication
(10) Pub. No.: US 2005/0181827 A1
(43) Pub. Date: Aug. 18, 2005

(54) Touch for feel device for communicating with mobile wireless phone or terminal

(75) Inventors: Riitta Nieminen-Sundell, Helsinki (FI); Niko Eiden, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/778,912

(22) Filed: Feb. 13, 2004

(51) Int. Cl. H04Q 7/20

(52) U.S. Cl. 455/557; 455/466; 455/41.2

(57) ABSTRACT

The invention provides a method and apparatus for transferring feelings between a first user and a second user over long distances, having a tactile module and a wireless connection module. The tactile module responds to an isolated tactile stimulus by a first user, for providing a tactile module signal containing information about the stimulus, and also responds to a wireless connection module signal containing information about a reply stimulus signal from a second user, for providing a reply stimulus that can be sensed by the first user. The wireless connection module responds to the tactile module signal, for providing a first wireless signal containing information about the stimulus to be received by a mobile phone or terminal, and also responds to a second wireless signal containing information about the reply stimulus and being received from the mobile phone or terminal, for providing the wireless connection module signal to the tactile module. The user stimulus module may have a pressure sensitive foil for responding to a touch stimulus from the first user.

### BACKGROUND OF THE INVENTION

1. Field of Invention

This invention relates to a device and method for communicating a so-called “touch” information to another person; and more particularly relates to a device and method for remotely communicating such a so-called “touch” information to another person via a mobile phone or terminal and wireless network.

2. Description of Related Art

Many phones ring or vibrate when receiving a phone call; however, there is no system or device known to the inventors that enables a user of a device to touch a person by an isolated tactile stimulus to the device, including touching or rubbing the device.

### SUMMARY OF INVENTION

In its broadest sense, the present invention provides a new and unique method and apparatus for providing so-called “touch for feel” or “touch for two” (hereafter T4T) device, which is a small device consisting of the following basic components:

1) An input module, for example, a pressure sensitive foil such as EMFi foil, for receiving an isolated tactile stimulus, including an isolated touch or rub, from a user,

2) A microcontroller(s) including memory for controlling the basic functionality of the T4T device,

3) An output device, for example, a vibrator having a small engine with off-balanced weight or piezo, for providing a reply stimulus from a corresponding user,

4) A battery for powering the T4T device, and

5) A Bluetooth chip or module and antenna for providing wireless communication between the T4T device and an associated mobile phone or terminal.

In effect, the present invention provides a new and unique T4T device for sending a remote touch from a user to a person over long distances, wherein the T4T device has a pressure sensitive foil for sensing a touch or rub by the user, and means for wirelessly connecting the device to a mobile phone for sending the remote touch to the person with tactile messaging. The means for wirelessly connecting the device to the mobile phone includes using a Bluetooth communications protocol.

The tactile messaging includes providing the remote touch to the person based on characteristics of the touch or rub by the user. The tactile messaging is intended to cover having different isolated tactile stimuli provided by the user correspond to associated different stimuli applied to the person. For example, one quick rub by the user may take the form of a quick vibratory pulse applied to the person, while a series of multiple quick rubs by the user may take the form a series of multiple quick vibratory pulses applied to the person.

In particular, the function of the T4T device of a particular user A is as follows:

1) Register touching of the device,

2) Send the “touch” information to the mobile phone or terminal over Bluetooth to be sent to a particular user B,

3) Receive “touch” information from the mobile phone or terminal from the user B, and

4) Playback the “touch” information through the vibrating unit.

The T4T device connects to the mobile phone or terminal through the Bluetooth protocol. The mobile phone or terminal has a T4T interface module with a small application running either in JAVA or SYMBIAN environment. The function of this application is to:

1) Communicate with T4T over Bluetooth,

2) Listen to the phone SMS/MMS stack to check if T4T specific messages have arrived and forward them to the T4T device,

3) Send “touch” information received from the T4T device automatically over the SMS/MMS stack to the user B phone, and

4) Be the user interface (UI) of T4T.

### EXAMPLE OF OPERATION

In operation, a first party may have, for example, a T4T device in the form of a piece of jewelry such as a necklace or a watch that is worn and makes contact with the skin.

At any given time, for example, during a boring meeting, the party can rub or contact a touch-sensitive part of their T4T jewelry, knowing that it sends a remote touch or stimulus to a second party, for example, their spouse, significant other, friend. The touch or stimulus may take many different forms, including a vibration, a change in temperature, a change in some coloration, etc. The first party does not have to be concerned about the sending process since the message can go only to the T4T device of the second party.

When the second party feels a vibration, for example, on their corresponding T4T jewelry, the second party knows it came from the first party since no one else can send remote touches to their corresponding T4T jewelry. The second party may strokes the touch sensitive pad of their corresponding T4T jewelry, and almost instantaneously, the first party receives a reply or answer, i.e. the first party's T4T jewelry reacts.

The T4T device and concept is based on communicating through the mobile devices the first and second parties carry. The jewelry with tactile input and output utilizes mobile terminals to transmit the messages over distance. The jewelry is designed to communicate within short range to the mobile devices.

The present invention has the following advantages:

1) The device provides a unique way to communicate your immediate feelings to another important person in their life non-verbally with a remote touch,

2) The device has a distinguished looks, tactile feel, and

3) The device provides a communication tool for anybody With an intensive relationship with someone.

### BRIEF DESCRIPTION OF THE DRAWING

The drawing, not drawn to scale, includes the following Figures:

FIG. 1 is a diagram of an overall systems architecture showing how one T4T device sends so-called “touch” information to another T4T device according to the present invention.

FIG. 2 is a block diagram of a T4T device according to the present invention.

FIG. 3 is a block diagram of a tactile module which forms part of the T4T device shown in FIG. 2.

FIG. 4 is a block diagram of a wireless connection module which forms part of the T4T device shown in FIG. 2.

FIG. 5 is a block diagram of a wireless connection module which forms part of the T4T device shown in FIG. 2.

### DETAILED DESCRIPTION OF INVENTION

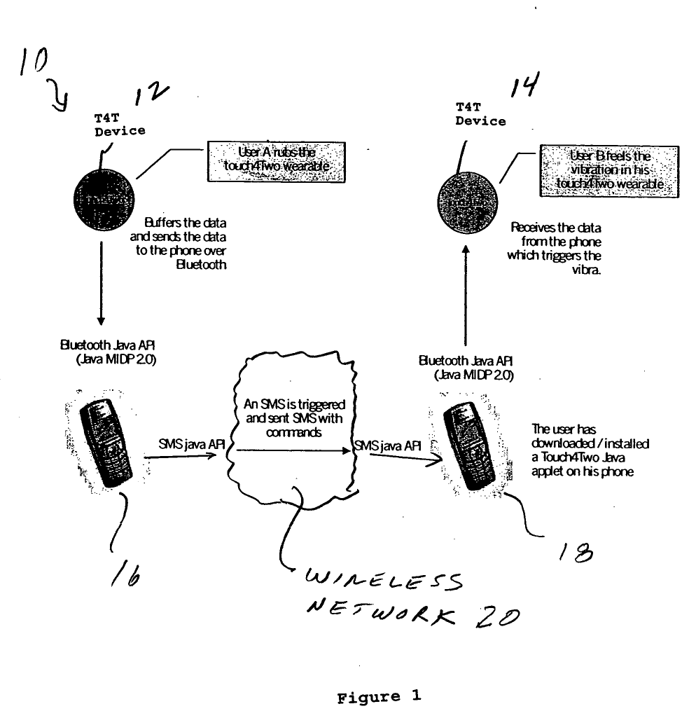

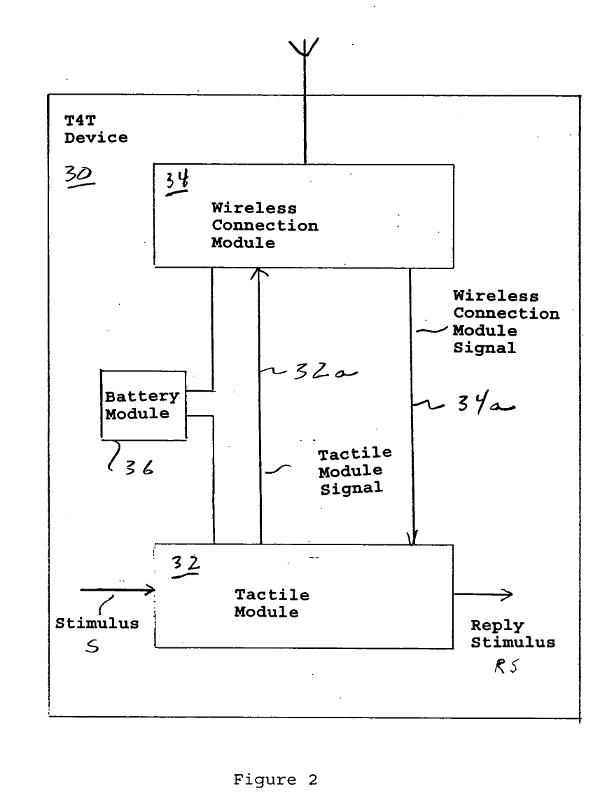

FIG. 1 shows an overall systems architecture generally indicated as 10 that enables one T4T device 12 worn by a user A to communicate with another T4T device 14 worn by a user B. The T4T device is shown and described in greater detail in relation to FIG. 2.

To start the process, for example, the user A provides a so-called “touch” to the T4T device 12, which may take the form of a touch, rub or some isolated tactile stimulus. The T4T device 12 has a suitable mechanism for responding to such a touch, rub or other isolated tactile stimulus, including but not limited to a aforementioned pressure sensitive foil or other suitable mechanism for responding to the same either now known or later developed in the future. For example, the pressure sensitive device may include either a touch screen, a touch pad, a capacitive sensor, a key, an EMFi foil, or other suitable touch sensitive device that reacts to a change in the electrical field and provides a signal containing information about the same. EMFi foil is an Electro Mechanical Film that is a foil like a flexible polymer film with a permanent electric charge. In response thereto, the T4T device 12 buffers “touch” information data and sends a suitable data signal containing information about the same to a mobile phone or terminal 16 using, for example, the Bluetooth protocol. Although the invention is described in relation to using the Bluetooth protocol, the scope of the present invention is not intended necessarily to be limited to the same. For example, the scope of the present invention is intended to include using other such wireless protocols either now known or later developed in the future including either an analog radio system, or infrared system.

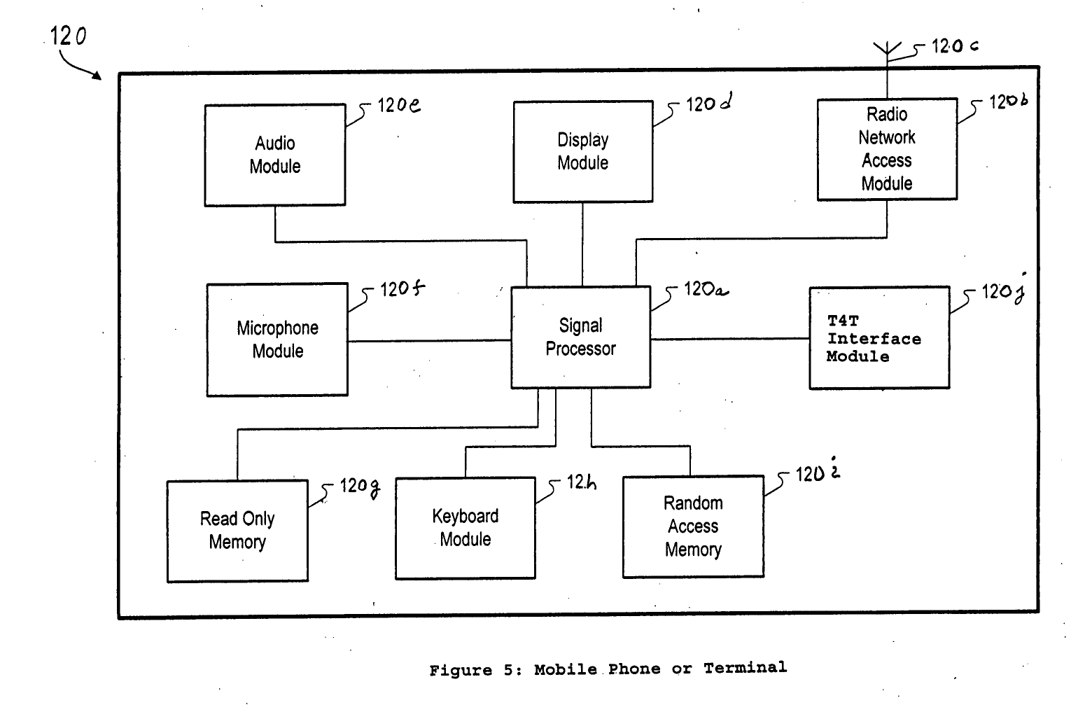

The mobile phone or terminal receives the data from the T4T device 12, which triggers an SMS java API message that is sent to a corresponding mobile phone or terminal 18 of user B via a wireless network 20. Consistent with that shown, each user(s) would have typically downloaded/installed a T4T java applet on the mobile phone or terminal, which may be stored in the mobile phone or terminal, such as in a T4T interface module 120j discussed in relation to FIG. 5 below. The mobile phone or terminal 16 is shown and described in greater detail in relation to FIG. 5. Although the invention is described in relation to using the SMS java API messaging protocol for communication from the mobile phone or terminal 16 to the mobile phone or terminal 18, the scope of the present invention is not intended to be limited to the same. For example, the scope of the present invention is intended to include using other suitable messaging protocols either now known or later developed in the future, or other suitable protocol for communicating between mobile phones or terminals. The mobile phone or terminal 18 receives the SMS java API message, and provides an appropriate data signal containing information about the so-called “touch” information from the user A to the T4T device 14 using the Bluetooth protocol or other suitable protocol consistent with that discussed above. The T4T device 14 receives the data signal from the mobile phone or terminal 18 which triggers a vibration, although the scope of the present invention is intended to include using other suitable sensory stimulating devices either now known or developed in the future. The user B feels the vibration, or senses the other suitable sensory stimulus, generated by the T4T device being worn.

### FIG. 2: The T4T Devices 12, 14 and 30

FIG. 2 shows a T4T device generally indicated 30, which is an example of either T4T devices 12 or 14 shown in FIG. 1, for transferring the so-called “touch” or feelings from the user A to the user B, or vice versa, over long distances. The T4T device 30 includes a tactile module 32 and a wireless connection module 34.

The tactile module 32 responds to an isolated tactile stimulus S by a first user, such as user A (FIG. 1), for providing a tactile module signal along line 32a containing information about the isolated tactile stimulus S, which may include an isolated rub, touch, or other suitable isolated tactile stimulus consistent with that discussed above. The tactile module 32 also responds to a wireless connection module signal along line 34a containing information about a reply stimulus signal from a second user, such as user B in FIG. 1, for providing a reply stimulus that can be sensed by the first user A. The reply stimulus signal may take the form of any wireless signal or any other suitable signal sent from one user of one T4T device to another user of another T4T device, such as devices 12, 14 (FIG. 1), to initiate a reply stimulus in response to some stimulus previously received from another user.

The wireless connection module 34 responds to the tactile module signal along line 32a, for providing a first wireless signal containing information about the stimulus S and being received by a mobile phone or terminal, such as mobile phone or terminal 16 in FIG. 1. The wireless connection module 34 also responds to a second wireless signal containing information about the reply stimulus and being received from the mobile phone or terminal, such as mobile phone or terminal 16 in FIG. 1, for providing the wireless connection module signal to the tactile module, which generates the reply stimulus consistent with that discussed above.

The T4T device 30 also includes a battery 36 for powering the tactile module 32 and the wireless connection module 34.

The tactile module 32 and wireless connection module 34 may be implemented using hardware, software, or a combination thereof. In a typical software implementation, the tactile module 32 and wireless connection module 34 would be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation.

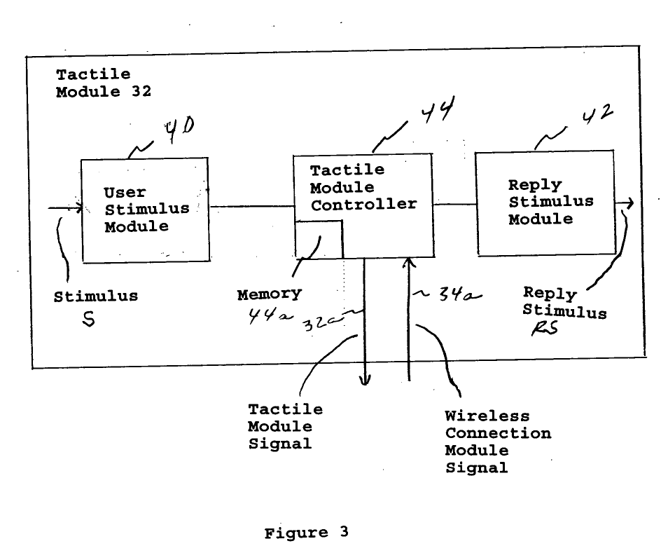

### FIG. 3: The Tactile Module 32

FIG. 3 shows in greater detail the tactile module 32 shown in FIG. 2, which includes a user stimulus module 40, a reply stimulus module 42 and a tactile module controller 44. Consistent with that discussed above, the user stimulus module 40 responds to an isolated tactile stimulus, including a touch or rub, from a user, such as user A or B in FIG. 1, and may include a pressure sensitive foil or other suitable mechanism for responding to a rub, touch or other stimulus from a user. Consistent with that discussed above, the reply stimulus module 42 may provide a reply stimulus to the user, and may include a vibrator or other suitable sensory stimulating device or devices. The tactile module controller 44 has a memory 44a for controlling the coordination between the user stimulus module 40 that responds to the stimulus from one user and the reply stimulus module 42 that provides the reply stimulus to the user.

The user stimulus module 40, reply stimulus module 42 and tactile module controller 44 may be implemented in whole or in part using hardware, software, or a combination thereof. In a typical software implementation, the user stimulus module 40, reply stimulus module 42 and tactile module controller 44 would be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation.

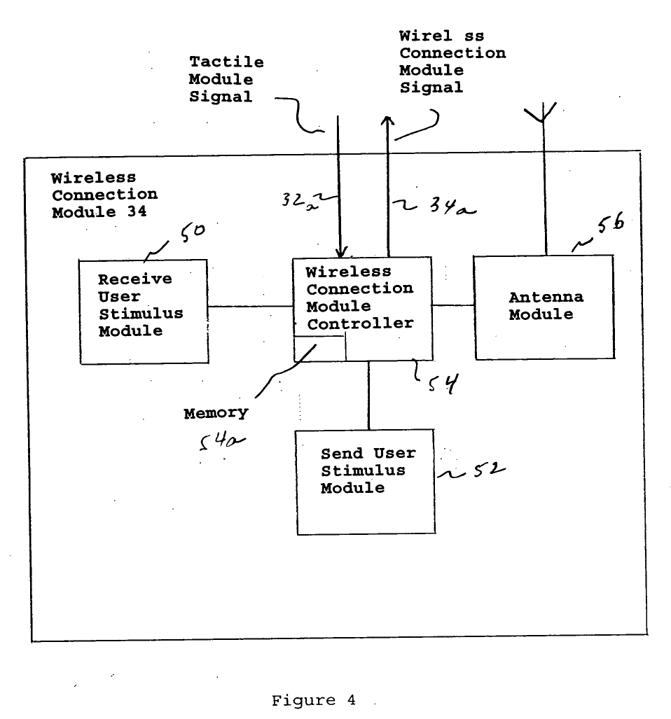

### FIG. 4: The Wireless Connection Module 34

FIG. 4 shows in greater detail the wireless connection module 34 shown in FIG. 2, which includes a receive user stimulus module 50, a send user stimulus module 52 and a wireless connection module controller 54 for coordinating the same in relation to an antenna module 56. Consistent with that discussed above, the receive user stimulus module 50 processes user stimulus messages received by the T4T device from the mobile phone or terminal, while the send stimulus module 52 processes user stimulus messages sent by the device to the mobile phone or terminal. Moreover, consistent with that discussed above, the device may communicate with the mobile phone or terminal using a Bluetooth wireless connection ot other suitable protocol. The wireless connection module controller 54 has a memory 54a for controlling the coordination between the receive user stimulus module 50 and the send stimulus user module 52 in relation to the antenna module 56.

The receive user stimulus module 50, send user stimulus module 52 and wireless connection module controller 54 may be implemented in whole or in part using hardware, software, or a combination thereof. In a typical software implementation, the receive user stimulus module 50, send user stimulus module 52 and wireless connection module controller 54 would be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation.

### FIG. 5: The Mobile Terminal 120

FIG. 5 shows a block diagram of the mobile phone or terminal 120 similar to the mobile phone or terminal 16 and 18 shown in FIG. 1, and includes a signal processor 120a connected to a radio access network module 120b (connected to an antenna 120c), a display module 120d, an audio module 120e, a microphone 120f, a read only memory 120g (ROM or EPROM), a keyboard module 120h and a random access memory 120i (RAM). The signal processor 120a controls the basic operation of wireless terminal 120, the operation of which is known in the art. Moreover, the scope of the invention is not intended to be limited to any particular kind or type of the aforementioned elements 120a, 120b, . . . , 120i. For example, the scope of the invention is intended to include the radio access network module 120b being either an antenna module, a radio frequency (RF) module, a radio modem or the like. The wireless terminal 120 may also include many other circuit elements known in the art which are not shown or described herein, since they do not form part of the immediate invention.

The mobile phone or terminal 120 also includes a T4T interface module 120j that controls interface functions between the mobile terminal 120 and the T4T device 12 or 14, as well as interface functions between the two mobile phones or terminals, such as the mobile terminal of the user A (FIG. 1) and the mobile phone or terminal of the user B (FIG. 1) via the network 20. For example, consistent with that discussed above, the interface functions include communicating with the T4T device using the Bluetooth or other suitable protocol discussed above, as well as communicating with the mobile phone or terminal of the other T4T device using the SMS/MMS or other suitable protocol via the network 20 (see FIG. 1).

The T4T interface module 120j may be implemented using hardware, software, or a combination thereof. In a typical software implementation, the T4T interface module 120j would be a microprocessor-based architecture having a microprocessor, a random access memory (PAM), a read only memory (ROM), input/output devices and control, data and address buses connecting the same. A person skilled in the art of programming would be able to program such a microprocessor-based implementation to perform the functionality described herein without undue experimentation.

The scope of the invention is not intended to be limited to any specific kind of mobile terminal or device, and many different mobile terminals or device, including laptop or notebook computers, are envisioned that may contain the fundamental features of the present invention described herein.

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A device for sending a remote touch from a user to a person over long distances, characterized in that
the device has a pressure sensitive device for sensing a touch or rub by the user, and has means for wirelessly connecting the device to a mobile phone for sending the remote touch to the person with tactile messaging.

2. A device according to claim 1, wherein the means for wirelessly connecting the device to the mobile phone includes using a Bluetooth communications protocol.

3. A device according to claim 1, wherein the tactile messaging includes providing the remote touch to the person based on characteristics of the touch or rub by the user.

4. A device for transferring feelings between a first user and a second user over long distances, comprising:
a tactile module having a touch sensitive part that responds to an isolated tactile stimulus, including a touch or rub, by a first user, for providing a tactile module signal containing information about the same, and further responsive to a wireless connection module signal containing information about a reply stimulus signal from a second user, for providing a reply stimulus that can be sensed by the first user; and
a wireless connection module, responsive to the tactile module signal, for providing a first wireless signal containing information about the isolated tactile stimulus and being received by a mobile phone or terminal, and further responsive to a second wireless signal containing information about the reply stimulus and being received from the mobile phone or terminal, for providing the wireless connection module signal to the tactile module.

5. A device according to claim 4, wherein the tactile module includes a user stimulus module for responding to a stimulus from the first user.

6. A device according to claim 5, wherein the user stimulus module has a pressure sensitive foil for responding to a touch stimulus from the first user.

7. A device according to claim 4, wherein the tactile module includes a reply stimulus module for providing a reply stimulus to the first user.

8. A device according to claim 7, wherein the reply stimulus module includes a vibrator for providing a reply touch stimulus to the first user.

9. A device according to claim 4, wherein the tactile module includes a tactile module controller having a memory for controlling the coordination between a user stimulus module that responds to a stimulus from the first user and a reply stimulus module for providing a reply stimulus to the first user.

10. A device according to claim 4, wherein the wireless connection module includes a receive user stimulus module for processing user stimulus messages received by the device from the mobile phone or terminal.

11. A device according to claim 10, wherein the device communicates with the mobile phone or terminal using a Bluetooth wireless connection.

12. A device according to claim 4, wherein the wireless connection module includes a send stimulus module for processing user stimulus sent by the device to the mobile phone or terminal.

13. A device according to claim 12, wherein the device communicates with the mobile phone or terminal using a Bluetooth wireless connection.

14. A device according to claim 4, wherein the wireless connection module includes a wireless connection module controller having a memory for controlling the coordination in relation to a receive user stimulus module for processing user stimulus received by the device from the mobile phone or terminal and a send stimulus user module for processing user stimulus sent by the device to the mobile phone or terminal.

15. A device according to claim 4, wherein the wireless connection module includes an antenna module for providing a wireless connection between the tactile module and the mobile phone or terminal.

16. A device according to claim 4, wherein the device includes a battery for powering the tactile module and the wireless connection module.

17. A device according to claim 4, wherein the device includes a means for the first user to wear the same on some body member.

18. A device according to claim 4, wherein the device includes a strap for the first user to wear the same.

19. A device according to claim 4, wherein the device includes a necklace for the first user to wear the same around the neck.

20. A network having devices for transferring feelings between a first user and a second user over long distances via mobile phones or terminals, each device for a respective user comprising:
a tactile module, responsive to an isolated tactile stimulus, including a touch or rub, by a first user, for providing a tactile module signal containing information about the same, and further responsive to a wireless connection module signal containing information about a reply stimulus from a second user, for providing the reply stimulus that can be sensed by the first user; and
a wireless connection module, responsive to the tactile module signal, for providing a first wireless signal containing information about the stimulus and being received by a mobile phone or terminal, and further responsive to a second wireless signal containing information about the reply stimulus and being received from the mobile phone or terminal, for providing the wireless connection module signal to the tactile module.

21. A network according to claim 20, wherein the mobile phones or terminals communicate using a short messaging service (SMS) protocol.

22. A network according to claim 20, wherein the tactile module includes a user stimulus module for responding to a stimulus from the first user.

23. A network according to claim 22, wherein the user stimulus module has a pressure sensitive foil for responding to the isolated tactile stimulus from the first user.

24. A network according to claim 20, wherein the tactile module includes a reply stimulus module for providing a reply stimulus to the first user.

25. A network according to claim 24, wherein the reply stimulus module includes a vibrator for providing a reply touch stimulus to the first user.

26. A network according to claim 20, wherein the tactile module includes a tactile module controller having a memory for controlling the coordination between a user stimulus module that responds to a stimulus from the first user and a reply stimulus module for providing a reply stimulus to the first user.

27. A network according to claim 20, wherein the wireless connection module includes a receive user stimulus module for processing user stimulus messages received by the device from the mobile phone or terminal.

28. A network according to claim 27, wherein the device communicates with the mobile phone or terminal using a Bluetooth wireless connection.

29. A network according to claim 20, wherein the wireless connection module includes a send stimulus module for processing user stimulus sent by the device to the mobile phone or terminal.

30. A network according to claim 29, wherein the device communicates with the mobile phone or terminal using a Bluetooth wireless connection.

31. A network according to claim 20, wherein the wireless connection module includes a wireless connection module controller having a memory for controlling the coordination in relation to a receive user stimulus module for processing user stimulus received by the device from the mobile phone or terminal and a send stimulus user module for processing user stimulus sent by the device to the mobile phone or terminal.

32. A network according to claim 20, wherein the wireless connection module includes an antenna module for providing a wireless connection between the device and the mobile phone or terminal.

33. A network according to claim 20, wherein the wireless device includes a battery for powering the tactile module and the wireless connection module.

34. A method for transferring feelings between a first user and a second user over long distances with wearable devices, comprising the steps of:
sensing an isolated tactile stimulus, including a touch or rub, from a first user and providing a first wireless signal to a mobile phone or terminal of the first user containing information about the isolated tactile stimulus for communication over a network to a second user; and
sensing a reply stimulus from the second user in response to a second wireless signal from the mobile phone or terminal containing information about the reply stimulus.

35. A method according to claim 34, wherein the method further comprises implementing the step of the method via a computer program running in a respective controller in each device.

36. A computer program product with a program code, which program code is stored on a machine readable carrier, for carrying out the steps according to claim 34 when the computer program is run in a processing means or controller in each device.

37. A mobile phone or terminal for interfacing with a device according to claim 4, wherein the mobile phone or terminal includes a T4T interface module that controls interface functions between the mobile phone or terminal and the device of a first user, as well as interface functions between another mobile phone or terminal and another device of another user B.

38. A mobile phone or terminal according to claim 37, wherein the interface functions include communicating with the device using the Bluetooth or other suitable protocol.

39. A mobile phone or terminal according to claim 37, wherein the interface functions include communicating with the other mobile phone or terminal of the other device of the other user B using the SMS/MMS or other suitable protocol via a network.

40. A device according to claim 1, wherein the pressure sensitive device includes either a touch screen, a touch pad, a capacitive sensor, a key, an EMFi foil, or other suitable touch sensitive device that reacts to a change in the electrical field and provides a signal containing information about the same.
